(19) United States
(12) Patent Application Publication
(10) Pub. No.: US 2009/0280361 A1
(43) Pub. Date: Nov. 12, 2009

(54) POWER SUPPLY SYSTEM AND METHOD OF CONTROLLING THE SAME

(75) Inventors: Hiroyasu Bitoh, Ome-shi (JP); Yasunari Kabasawa, Hanno-shi (JP); Yoshihiro Kawamura, Akiruno-shi (JP); Masaharu Shioya, Akiruno-Shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: CASIO COMPUTER CO.,LTD., TOKYO (JP)

(21) Appl. No.: 11/995,788

(22) PCT Filed: Jul. 31, 2006
(86) PCT No.: PCT/JP2006/315548

§ 371 Date: Jan. 15, 2008

(30) Foreign Application Priority Data
Aug. 1, 2005 (JP) 2005-222945
Jun. 6, 2006 (JP) 2006-157521

(51) Int. Cl. H01M 8/06; H01M 8/04

(52) U.S. Cl. 429/17; 429/20

(57) ABSTRACT

A power supply system using a fuel cell comprises a chemical reaction section (100) including, a evaporation section (103, 112, 114) that receives a power generation fuel and water supplied to it, heating at least the water supplied to it to evaporate it and a reaction section (105, 107) that generates a power generation gas on the basis of the steam generated by the evaporation section and the power generation fuel, a fuel supply section (P1, V1) that supplies the power generation fuel to the chemical reaction section, a water supply section (P2, V2) that supplies water to the chemical reaction section and a control section (130) that controls the operation of the system so as to stop supply of the power generation fuel from the fuel supply section to the chemical reaction section when the evaporation section is not in a condition suitable for evaporating operation. The power supply system suppresses any rise of the carbon monoxide concentration at the time of starting and stopping the system and prevents the power generation performance of the system from degrading.

### TECHNICAL FIELD

The present invention relates to a power supply system, a method of controlling a power supply system and an electronic apparatus comprising such a power supply system. More particularly, the present invention relates to a power supply system using a fuel cell and a method of controlling such a power supply system.

### BACKGROUND ART

Various chemical cells have been and are being popularly used in daily lives and also in many different fields of industry. Electric cells include primary cells such as alkaline dry cells and manganese dry cells and secondary cells such as nickel-cadmium cells, nickel-hydrogen cells and lithium ion cells to name only a few. Meanwhile, researches and developments of power supply systems using fuel cells have been and are under way for years for practical applications because fuel cells affect the environment only little (to put only a small load on the environment) and can realize a high efficiency of about 30 to 40% for energy utilization. Additionally, efforts are being paid for developing downsized power supply systems using fuel cells for the purpose of applying such systems to power units of mobile equipment, electric automobiles and the like.

Fuel reforming type fuel cells designed to be used in such power supply systems are known. Fuel reforming type fuel cells comprise a chemical reaction section, which typically includes a reformer for reforming fuel to be used for generating power that contains hydrocarbon compounds by way of a chemical reaction using a catalyst and reformed gas produced from the chemical reaction section is supplied to a power generation cell to generate power by using hydrogen contained in the reformed gas.

It is also known that carbon monoxide (CO) is produced to a slight extent in power supply systems using such a fuel reforming type fuel cell in the course of producing reformed gas by the chemical reaction section. More specifically, fuel is reformed by supplying a power generation fuel such as methanol and water to the chemical reaction section, evaporating and mixing them and supplying the mixture gas to the reformer, where the mixture gas is turned to reformed gas mainly containing hydrogen and at this time CO is generated to a slight extent as byproduct. Therefore, the chemical reaction section also includes a CO remover for removing carbon monoxide contained in the reformed gas.

However, the power generation fuel such as methanol is apt to evaporate more easily than water when the power supply system is started or stopped. Then, there can take place a condition where the content ratio of the power generation fuel gas in the mixture gas temporarily rises relative to steam. If the content ratio of the power generation fuel gas in the mixture gas temporarily rises relative to steam, it is no longer possible to completely reform the power generation fuel gas in the reformer. Then, unreformed power generation fuel gas is produced from the reformer. As a result, the catalyst in the CO remover is deteriorated by the unreformed power generation fuel gas to reduce the CO removing capacity of the CO remover to consequently raise the CO concentration.

Additionally, CO, formic acid and formaldehyde are produced as such unreformed power generation fuel gas flows into the power generation cell. Formic acid and formaldehyde damage the power generation cell to reduce the power generation capacity of the power generation cell. On the other hand, CO produced in the reformer and the power generation cell is harmful to the human body and deteriorates the catalyst in the power generation cell, which may typically be Pt, to further reduce the efficiency of power generation.

Arrangements are known for maintaining the content ratio of the power generation fuel gas in the mixture gas to a proper level by separately providing a concentration sensor for observing the concentration of the power generation fuel gas in the mixture gas and controlling the composition of reformed gas so as not to allow the CO concentration to rise according to the observed value of the concentration sensor. However, since a concentration sensor has to be provided separately to raise the cost and the number of parts, such an arrangement baffles efforts for downsizing.

There are known power supply systems that can suppress a rise of CO concentration by providing a CO concentration meter separately to observe the CO concentration and, if the CO concentration is high, suspending the supply of reformed gas into the power generation cell by switching a changeover valve. However, such an arrangement of providing a CO concentration meter and a changeover valve, which are costly, is disadvantageous from the cost viewpoint and entails an increased number of parts to consequently baffle efforts for downsizing.

### DISCLOSURE OF INVENTION

The present invention provides an advantage of suppressing the rise of carbon monoxide concentration that can take place when a power supply system using a fuel cell is started or stopped without providing an gauging instrument such as a concentration sensor to prevent the power generation performance of the power supply system from degrading and that of allowing the power supply system to be downsized.

According to the present invention, there is provided a power supply system comprising: a chemical reaction section comprising: a evaporation section that receives a power generation fuel and water supplied to it, heats at least the water supplied to it to evaporate it; and a reaction section that generates a power generation gas on the basis of the steam generated by the evaporation section and the power generation fuel; a fuel supply section that supplies the power generation fuel to the chemical reaction section; a water supply section that supplies water to the chemical reaction section; and a control section that controls the operation of the system so as to stop supply of the power generation fuel from the fuel supply section to the chemical reaction section when the evaporation section is not in a condition suitable for evaporating operation.

Preferably, the evaporation section is so arranged as to evaporate the power generation fuel supplied to it. Then, preferably, the evaporation section comprises a first evaporation section that heats and evaporates the water, a second evaporation section that evaporates the power generation fuel supplied to it and a mixer that mixes the steam produced by the first evaporation section and the evaporated power generation fuel produced by the second evaporation section and supplies the mixture to the reaction section.

When the power generation fuel is a liquid fuel containing the hydrogen atom, the evaporation section evaporates the water and the power generation fuel and the reaction section comprises a reform section that receives the mixture gas of the power generation fuel and steam evaporated by the evaporation section and produces hydrogen-containing reformed gas by means of a reform reaction and a carbon monoxide removal section that removes carbon monoxide contained in the reformed gas and produces the power generation gas.

When the power generation fuel is a gas fuel containing the hydrogen atom, the reaction section comprises a reform section that receives the mixture gas of steam produced by the evaporation section and gas fuel and produces hydrogen-containing reformed gas by means of a reform reaction and a carbon monoxide removal section that removes carbon monoxide contained in the reformed gas and produces the power generation gas.

Preferably, the power supply system further comprises a temperature detection section that detects the temperature of the evaporation section and the control section controls so as to stop supply of the power generation fuel from the fuel supply section to the chemical reaction section when the temperature of the evaporation section as detected by the temperature detection section is lower than a predetermined temperature, which may typically be the boiling point of water.

Preferably, the power supply system further comprises a power generation section that receives the power generation gas supplied to it and generates power that drives a load by way of an electrochemical reaction and the load is typically an electronic apparatus. Preferably, the power supply system is at least partly integrally formed with the load and comprises a fuel containing section containing the power generation fuel in a sealed condition and the power supply system is integrally formed with the load except the fuel containing section. Preferably, the power supply system is formed as a module that is configured to removably fitted to the load.

When starting operating the power generation section, the control section causes the evaporation section to start operating and also the water supply section to start supplying water to the chemical reaction section, and causes the fuel supply section to supply the power generation fuel to chemical reaction section after the evaporation section comes into a condition suitable for the operation of evaporating water.

Preferably, the power supply system further comprises an output detection section that detects the output of the power generation section and when stopping operating the power generation section, the control section stops the supply of the power generation fuel from the fuel supply section to the chemical reaction section, causes the evaporation section to stop operating after the output of the power generation section detected by the output detection section falls under a predetermined value and stops the supply of water from the water supply section to the chemical reaction section.

According to the present invention, there is also provided a method of controlling a power supply system which comprises a chemical reaction section comprising: a evaporation section for receiving a power generation fuel and water supplied to it and heating and evaporating water; a reaction section for generating a power generation gas on the basis of the steam generated by the evaporation section and the power generation fuel; and a power generation section for receiving the power generation gas supplied to it and generating power by way of an electrochemical reaction; wherein when starting to operate the power generation section, the method comprises causing the evaporation section to start operating and causing the water supply section to start supplying water to the chemical reaction section, waiting until the evaporation section comes into a condition suitable for the operation of evaporating water and causing the fuel supply section to start supplying the power generation fuel to chemical reaction section when the evaporation section comes into a condition suitable for the operation of evaporating water.

Preferably, the power supply system further comprises a temperature detection section that detects the temperature of the evaporation section and the sequence of waiting until the evaporation section comes into a condition suitable for the operation of evaporating water comprises a sequence of waiting until the temperature of the evaporation section detected by the temperature detection section becomes higher than a predetermined temperature, which may typically be the boiling point of water.

Preferably, when stopping the operation of the power generation section, the method comprises a sequence of stopping the supply of the power generation fuel from the fuel supply section to the chemical reaction section, waiting until the output of the power generation section falls under a predetermined value and, when the output of the power generation section falls under the predetermined value, causing the evaporation section to stop operating and also the water supply section to stop supplying water to the chemical reaction section.

Preferably, the power supply system further comprises an output detection section that detects the output of the power generation section and the sequence of waiting until the output of the power generation section falls under the predetermined value comprises a sequence of waiting until the output of the power generation section detected by the output detection section falls under the predetermined value.

### BRIEF DESCRIPTION OF DRAWINGS

FIG. 1 is a schematic block diagram of a first embodiment of power supply system according to the present invention;

FIG. 2 is a flowchart of the start control process of the embodiment of FIG. 1;

FIG. 3 is a flowchart of the stop control process of the embodiment of FIG. 1;

FIG. 4 is a schematic block diagram of a second embodiment of power supply system according to the present invention;

FIG. 5 is a flowchart of the start control process of the embodiment of FIG. 4;

FIG. 6 is a flowchart of the stop control process of the embodiment of FIG. 4;

FIG. 7 is a schematic block diagram of a third embodiment of power supply system according to the present invention;

FIG. 8 is a flowchart of the start control process of the embodiment of FIG. 7;

FIG. 9 is a flowchart of the stop control process of the embodiment of FIG. 7;

FIG. 10 is a schematic perspective view of a power generation unit realized by applying a power generation system according to the present invention;

FIG. 11 is a schematic perspective view of an electronic apparatus adapted to use a power generation unit realized by applying a power generation system according to the present invention; and

FIGS. 12A, 12B and 12C are tri-lateral views of another electronic apparatus adapted to use a power supply system according to the present invention.

### BEST MODE FOR CARRYING OUT THE INVENTION

Now, a power supply system and a method of controlling a power supply system according to the present invention will be described in detail by referring to the accompanying drawings that illustrate preferred embodiments of the invention along with electronic apparatus comprising a power supply system according to the present invention.

### First Embodiment

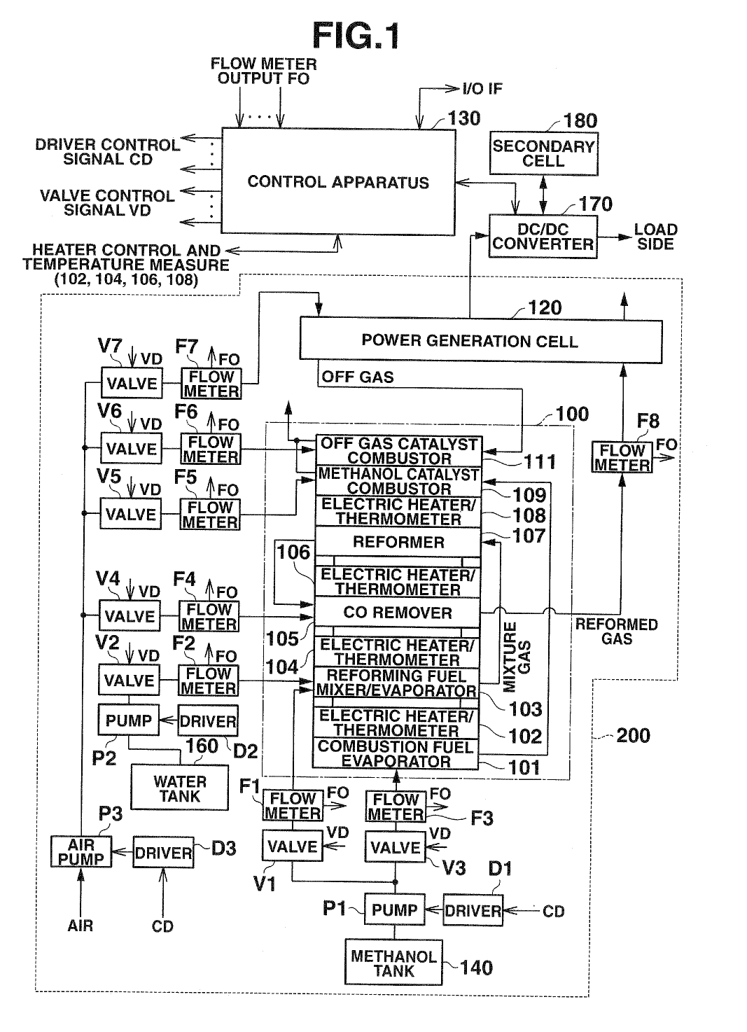

Firstly, the configuration of the first embodiment of power supply system according to the invention will be described by referring to FIG. 1. The power supply system of this embodiment comprises a fuel reforming type solid state polymer electrolyte fuel cell (PEFC) and is adapted to use liquid fuel such as methanol as the power generation fuel.

FIG. 1 is a schematic block diagram of the first embodiment of power supply system according to the present invention, showing the configuration thereof.

The power supply system of this embodiment comprises a control apparatus (control section) 130, a DC/DC converter (voltage transformation section) 170, a secondary cell 180 and a fuel reforming type fuel cell system 200.

The fuel cell system 200 includes a chemical reaction section 100, a power generation cell (power generation section) 120, a methanol tank (fuel containing section) 140, a water tank 160, pumps P1 through P3, valves V1 through V7 and flow meters F1 through F8.

The chemical reaction section 100 by turn includes a combustion fuel evaporator 101, an electric heater/thermometer 102, a reforming fuel mixer/evaporator (evaporation section) 103, another electric heater/thermometer 104, a CO remover (carbon monoxide removing section) 105, another electric heater/thermometer 106, a reformer (reforming section) 107, another electric heater/thermometer 108, a methanol catalyst burner 109 and an off gas catalyst burner 111.

The chemical reaction section 100 may also include a container for covering at least the CO remover 105, the electric heater/thermometer 106, the reformer 107, the electric heater/thermometer 108, the methanol catalyst burner 109 and an off gas catalyst burner 111 with or without other components in order to maintain at least the reformer 107 and the CO remover 105 to a predetermined temperature and the inside of the container may be exhausted to show a vacuum insulation structure.

The secondary cell 180 may be formed by using a capacitor for holding an electric charge.

The methanol tank 140 contains methanol (power generation fuel) and the water tank 160 contains water to be used by the reformer 107 for reforming reactions.

The combustion fuel evaporator 101 receives part of the methanol contained in the methanol tank 104 that is injected into it by means of the pump P1 as combustion fuel, heats and evaporates(vaporizes) the methanol and sends it out to the methanol catalyst burner 109 as methanol gas. The flow rate of methanol injected into the combustion fuel evaporator 101 is regulated by the valve V3 and gauged by the flow meter F3. The electric heater/thermometer 102 functions as an electric heater for heating the combustion fuel evaporator 101 and also as a thermometer for gauging the temperature of the combustion fuel evaporator 101.

The methanol catalyst burner 109 mixes methanol gas supplied from the combustion fuel evaporator 101 and air supplied from the air pump P3 and burns the mixture gas by means of a catalyst. The heat of combustion of the mixture gas is used to heat the reformer 107, the CO remover 105 and other components of the chemical reaction section 100 and set them to a predetermined reaction temperature. The flow rate of air supplied to the methanol catalyst burner 109 is regulated by the valve V5 and gauged by the flow meter F5. After burning the mixture gas, exhaust gas is discharged to the outside of the power generation system.

The reforming fuel mixer/evaporator 103 mixes methanol (power generation fuel) injected from the methanol tank 140 by means of the pump P1 and water injected from the water tank 160 by means of the pump P2 and heats and evaporates(vaporizes) the mixture to produce the mixture gas. Then, it sends the mixture gas to the reformer 107. The flow rate of methanol injected into the reforming fuel mixer/evaporator 103 is regulated by the valve V1 and gauged by the flow meter F1. The flow rate of water injected into the reforming fuel mixer/evaporator 103 is regulated by the valve V2 and gauged by the flow meter F2. The electric heater/thermometer 104 functions as an electric heater for heating the reforming fuel mixer/evaporator 103 and at the same time as a thermometer for gauging the temperature of the reforming fuel mixer/evaporator 103.

The reformer 107 heats the mixture gas supplied from the reforming fuel mixer/evaporator 103 to about 300° C., reforms it by way of a reform reaction as expressed by formula (1) shown below and sends it out to the CO remover 105 as hydrogen-containing reformed gas (power generation gas).

CH₃OH+H₂O→3H₂+CO₂ (1)

In the reformer 107, carbon monoxide CO is produced to a slight extent as byproduct by way of an inverse shift reaction as expressed by formula (2) shown below.

CO₂+H₂→CO+H₂O (2)

The electric heater/thermometer 108 functions as an electric heater for heating the reformer 107 and at the same time as a thermometer for gauging the temperature of the reformer 107.

The CO remover 105 heats and mixes reformed gas supplied form the reformer 107 and air supplied from the air pump P3 and selectively oxides carbon monoxide by way of a shift reaction as expressed by formula (3) below.

CO+H₂O→H₂+CO₂ (3)

Additionally, a catalyst such as Pt or Al₂O₃ is held in the inside of the CO remover 105 in order to make the chemical reaction expressed by the formula (3) proceed efficiently. Furthermore, the CO remover 105 oxides CO by way of a chemical reaction as expressed by formula (4) below.

2CO+O₂→2CO₂ (4)

Then, the CO remover 105 sends out the reformed gas from which CO is removed by way of chemical reactions expressed by the formulas (3) and (4) to the power generation cell 120. The flow rate of air supplied to the CO remover 105 is regulated by the valve V4 and gauged by the flow meter F4. The electric heater/thermometer 106 functions as an electric heater for heating the CO remover 105 and at the same time as a thermometer for gauging the temperature of the CO remover 105.

The power generation cell 120 includes a plurality of power generating cells, each having a fuel pole formed on one of the opposite surfaces of an electrolyte MEA (Membrane Electrode Assembly) and an air pole formed on the other surface thereof. Micro-particles of a catalyst such as Pt or Pt—Ru are made to adhere to the fuel pole and the air pole. As hydrogen-containing reformed gas is supplied to the fuel pole from the reformer 107, hydrogen ions (protons: H⁺) are produced by the above-described catalyst by way of a chemical reaction expressed by formula (5) below due to separation of electrons (e⁻) and transmitted to the air pole by way of an ion conducting membrane, while electrons (e⁻) are taken out by the carbon electrode of the fuel pole and supplied to a load.

3H₂→6H⁺+6e⁻ (5)

On the other hand, as air is supplied to the air pole by the air pump P3, electrons (e⁻) coming through the load, hydrogen ions (H⁺) and oxygen gas in air are made to react with each other by the above-described catalyst to produce water (3H₂O) by way of a chemical reaction expressed by formula (6) below.

6H⁺+3/2O₂+6e⁻→3H₂O (6)

The electrochemical reactions of the formulas (5) and (6) progress under a temperature condition of 60 to 80° C. Then, the power generation cell 120 supplies electric power generated by the electrochemical reactions of the formulas (5) and (6) to the DC/DC converter 170. The flow rate of reformed gas supplied to the power generation cell 120 is gauged by the flow meter F8. The flow rate of air supplied to the power generation cell 120 is regulated by the valve V7 and gauged by the flow meter F7. The power generation cell 120 sends out reformed gas that is not consumed by the formula (5) to the off gas catalyst burner 111 as off gas.

The DC/DC converter 170 produces an output of a predetermined voltage by means of the accumulated power with which the secondary cell 180 is charged when the fuel cell system 200 is started or an overload arises, whereas it regulates the output power of the power generation cell 120 by switching regulation and supplies power to the external load while it also electrically charges the secondary cell 180 when the fuel cell system 200 is operating steadily.

The off gas catalyst burner 111 mixes off gas supplied from the power generation cell 120 and air supplied from the air pump P3 and burns the mixture by means of catalyst. The heat of combustion then employed to heat the reformer 107, the CO remover 105 and other components of the chemical reaction section 100 and set up a predetermined reaction temperature. The flow rate of air supplied to the off gas catalyst burner 111 is regulated by the valve V6 and gauged by the flow meter F6. After combustion, exhaust gas is discharged to the outside of the power generation system.

The control apparatus 130 is typically formed by using a CPU, a ROM, a RAM, an A/D converter and a D/A converter and controls the operations of the components of the system. More specifically, the control apparatus 130 controls the operations of the components of the system as the CPU executes various control programs stored in the ROM, using the flow rates FO gauged by the flow meters F1 through F8, the temperatures observed by the electric heater/thermometers 102, 104, 106 and 108 and the current output level of the power generation cell 120. In other words, the control apparatus 130 outputs valve control signals VD for respectively driving the valves V1 through V7, driver control signals CD for issuing control commands to drivers D1 through D3 for respectively driving/controlling the pumps P1 through P3 and heater control signals for respectively controlling the operations of driving the electric heaters of the electric heater/thermometers 102, 104, 106 and 108.

Now, the cause of producing unreformed methanol gas will be described below.

From the formula (1) it will be seen that theoretically the best efficiency is obtained when the mixing ratio of the mixture gas of steam and methanol gas is 1:1. However, since the boiling point of methanol (65° C.) is lower than the boiling point of water (100° C.), water is not evaporated yet and only methanol is evaporated when the temperature in the reforming fuel mixer/evaporator 103 is rising and has become higher than the boiling point of methanol but still has not got to the boiling point of water after the start of the power supply system. Likewise, evaporation of water stops but that of methanol goes on when the temperature in the reforming fuel mixer/evaporator 103 is falling and has become lower than the boiling point of water but still has not got to the boiling point of methanol after the stop of the power supply system. Under such conditions, the proportion of methanol relative to steam in the mixture gas of methanol and steam becomes higher and the reformer 107 cannot thoroughly reform methanol by way of a reforming reaction as expressed by the formula (1) to consequently give rise to unreformed methanol.

As unreformed methanol is produced in the reformer 107, it is sent out to the CO remover 105 to deteriorate the catalyst held on the CO remover 105 and remarkably lower the CO removing rate of the CO remover 105. Then, the CO remover 105 can no longer thoroughly remove CO by way of a shift reaction as expressed by the formula (2) to consequently raise the CO concentration.

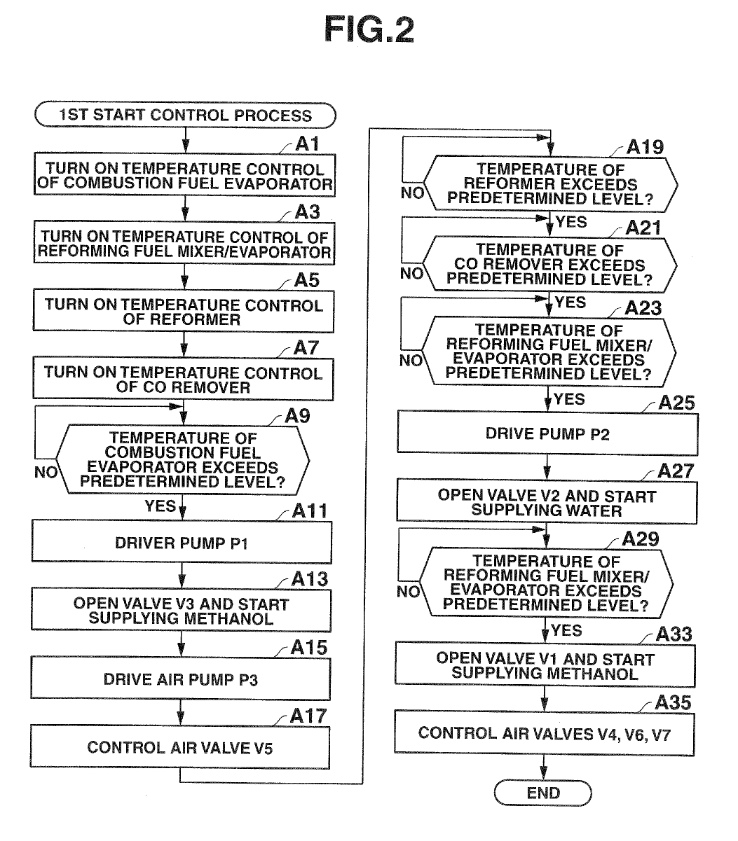

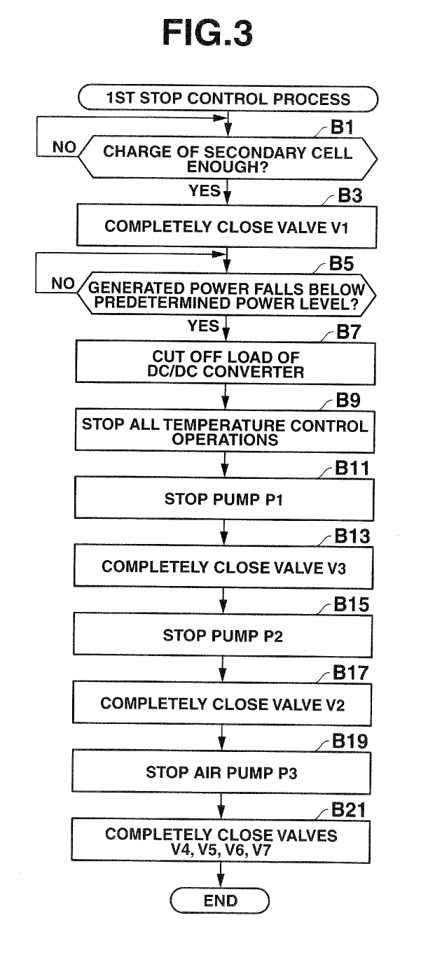

Now, the operation of the power supply system of this embodiment will be described below by referring to FIGS. 2 and 3.

FIG. 2 is a flowchart of the start control process of the embodiment of FIG. 1.

FIG. 3 is a flowchart of the stop control process of the embodiment of FIG. 1.

Firstly, referring to FIG. 2, the start control process of this embodiment (the first start control process) will be described below. The first start control process is a process that is executed when the control apparatus 130 causes the fuel cell system 200 to start operating.

The control apparatus 130 firstly outputs a heater control signal for starting a temperature control operation to each of the electric heater/thermometers 102, 104, 106 and 108 in order to make them respectively start controlling the temperatures of the combustion fuel evaporator 101, the reforming fuel mixer/evaporator 103, the reformer 107 and the CO remover 105 (Steps A1, A3, A5, A7).

Then, the control apparatus 130 determines if the temperature of the combustion fuel evaporator 101 gauged by the electric heater/thermometer 102 has exceeded a predetermined temperature level or not (Step A9). The control apparatus 130 waits until the temperature exceeds the predetermined temperature level (Step A9: No). The processing operation of Step A9 is performed to determine if the temperature of the combustion fuel evaporator 101 has got to a temperature level that is sufficiently high for evaporating at least methanol (e.g., about 65° C. which is the boiling point of methanol) or not.

When the temperature of the combustion fuel evaporator 101 rises above the predetermined temperature level (Step A9: Yes), the control apparatus 130 outputs a signal for causing the control driver D1 to start driving the pump P1 for supplying methanol (Step A11) and also a signal for causing it to open the valve V3 in order to start supplying methanol to the combustion fuel evaporator 101 (Step A13).

Then, the control apparatus 130 outputs a signal for causing the driver D3 to drive the air pump P3 for supplying air to the power supply system (Step A15) and also a signal for causing it to open the valve V5 in order to start supplying air to the methanol catalyst burner 109 (Step A17). As a result of the processing operations in Steps A11 through A17, methanol gas evaporated by the combustion fuel evaporator 101 is sent out to the methanol catalyst burner 109 and burnt with air on the catalyst in the methanol catalyst burner 109. The produced heat of combustion is then used to heat the reformer 107, the CO remover 105 and other components of the chemical reaction section 100.

Thereafter, the control apparatus 130 determines if the temperature of the reformer 107 gauged by the electric heater/thermometer 108 has exceeded a predetermined temperature level or not (Step A19). The control apparatus 130 waits until the temperature exceeds the predetermined temperature level (Step A19: No). The processing operation of Step A19 is performed to determine if the temperature of the reformer 107 has got to a temperature level that is sufficiently high for at least proceeding with a reforming reaction expressed by the formula (1) (e.g., about 300° C.) or not.

When the temperature of the reformer 107 rises above the predetermined temperature level (Step A19: Yes), the control apparatus 130 determines if the temperature of the CO remover 105 gauged by the electric heater/thermometer 106 has exceeded a predetermined temperature level or not (Step A21). The control apparatus 130 waits until the temperature exceeds the predetermined temperature level (Step A21: No). The processing operation of Step A21 is performed to determine if the temperature of the CO remover 105 has got to a temperature level that is sufficiently high for at least proceeding with chemical reactions expressed by the formulas (3) and (4) (e.g. 60 to 80° C.) or not.

When the temperature of the CO remover 105 rises above the predetermined temperature level (Step A21; Yes), the control section 130 determines if the temperature of the reforming fuel mixer/evaporator 103 gauged by the electric heater/thermometer 104 has exceeded a predetermined temperature level or not (Step A23). The control apparatus 130 waits until the temperature exceeds the predetermined temperature level (Step A23: No). The processing operation of Step A23 is performed to determine if the temperature of the reforming fuel mixer/evaporator 103 has got to a temperature level that is sufficiently high for at least evaporating water (e.g., about 100° C. which is the boiling point of water) or not.

When the temperature of the reforming fuel mixer/evaporator 103 rises above the predetermined temperature (Step A23: Yes), the control apparatus 130 outputs a signal for causing the driver D2 to drive the pump P2 for supplying water (Step A25) and also a signal for causing it to open the valve V2 in order to start supplying water to the reforming fuel mixer/evaporator 103 (Step A27). Since only water is supplied to the reforming fuel mixer/evaporator 103 and no methanol is supplied to it, the reforming fuel mixer/evaporator 103, the reformer 107, the CO remover 105 and the piping connecting them are gradually filled with steam.

Then, the control apparatus 130 determines if the temperature of the reforming fuel mixer/evaporator 103 gauged by the electric heater/thermometer 104 has exceeded a predetermined temperature level or not (Step A29). The control apparatus 130 waits until the temperature exceeds the predetermined temperature level (Step A29: No). The processing operation of Step A29 is performed to determine once again if the temperature of the reforming fuel mixer/evaporator 103 that has fallen temporarily by the water injected into the reforming fuel mixer/evaporator 103 in the processing operations of Steps A25 and A27 exceeds a temperature level that is sufficiently high for at least evaporating water (e.g., about 100° C. which is the boiling point of water) or not.

Subsequently, when the temperature of the reforming fuel mixer/evaporator 103 rises above the predetermined temperature level (Step A29: YES), the control apparatus 130 outputs a signal for opening the valve V1 to start supplying methanol to the reforming fuel mixer/evaporator 103 (Step A33). As a result of the processing operation in Step A33, methanol is supplied to the reforming fuel mixer/evaporator 103 and the reforming fuel mixer/evaporator 103 evaporates methanol and produces the mixture gas of methanol gas and steam, which the mixture gas is then sent out to the reformer 107. Thus, a reforming reaction as expressed by the formula (1) progresses in the reformer 107.

Then, the control apparatus 130 outputs a signal for opening the valves V4, V6 and V7 to start supplying air to the CO remover 105, the off gas catalyst burner 111 and the power generation cell 120 (Step A35).

As a result, shift reactions as expressed by the formulas (3) and (4) progress in the CO remover 105 and a catalyst combustion reaction progresses in the off gas catalyst burner 111, while electrochemical reactions as expressed by the formulas (5) and (6) progress in the power generation cell 120 so that the power generation cell 120 starts generating electricity.

Now, referring to FIG. 3, the stop control process of this embodiment (the first stop control process) will be described below.

The first stop control process is a process that is executed when the control apparatus 130 causes the fuel cell system 200 to stop operating.

The control apparatus 130 firstly determines if the electric power accumulated in the secondary cell 180 that is charged from the DC/DC converter 170 exceeds a predetermined power level or not in order to determine if the charge of the power supply system is enough or not (Step B1). The control apparatus 130 waits until it determines that the charge is enough (Step B1: No). The processing operation of Step B1 is performed to stop the operation of the fuel cell system 200 only after accumulating enough electric power for starting the fuel cell system 200 so that the fuel cell system 200 may be started smoothly next time because the power supply system is started to operate by using the electric power accumulated in the secondary cell 180 and the power supply system cannot be started if the electric power accumulated in the secondary cell 180 is not enough.

If it is determined that the electric power accumulated is enough (Step B1: Yes), the control apparatus 130 outputs a control signal for completely closing the valve V1 for supplying methanol to the reforming fuel mixer/evaporator 103 and cuts off the supply of methanol to the reforming fuel mixer/evaporator 103 (Step B3). At this time, the valve V2 for supplying water to the reforming fuel mixer/evaporator 103 is still held open. Thus, as a result of the processing operation of Step B3, the supply of methanol to the reforming fuel mixer/evaporator 103 is intercepted and only water is supplied to it.

Then, the control apparatus 130 determines if the electric power generated by the power generation cell 120 is lower than a predetermined power level or not by way of the DC/DC converter 170 (Step B5) and waits until the electric power generated by the power generation cell 120 becomes lower than the predetermined power level (Step B5: No). At this time, no methanol is supplied to the reforming fuel mixer/evaporator 103 and only water is supplied to it. Meanwhile, although the reforming reaction in the reformer 107 continues, reformed gas is no longer produced and supplied to the power generation cell 120 when all the unreformed methanol gas is reformed in the reformer 107. Then, the power output of the power generation cell 120 gradually falls. Thus, the processing operation of Step B5 is performed to detect that all the unreformed methanol gas has been reformed.

Then, as the power output of the power generation cell 120 falls under a predetermined power level (Step B5: Yes), the control apparatus 130 stops the supply of electric power to the load by way of the DC/DC converter 170 (Step B7).

Thereafter, the control apparatus 130 outputs a heater control signal to each of the electric heater/thermometers 102, 104, 106 and 108 (Step B9) in order to make them stop their respective temperature controlling operations. It also outputs a signal for causing the control driver D1 to stop driving the pump P1 for supplying methanol (Step B11) and issues a command for completely closing the valve V3 to cut off the supply of methanol to the combustion fuel evaporator 101 (Step B13). As a result of the processing operations in Steps B9 through B13, the electric heater/thermometers 102, 104, 106 and 108 stop their respective temperature controlling operations and the supply of methanol to the combustion fuel evaporator 101 is stopped.

Subsequently, the control apparatus 130 outputs a signal for causing the control driver D2 to stop driving the pump P2 for supplying water to the reforming fuel mixer/evaporator 103 (Step B15) and also a signal for completely closing the valve V2 so as to completely close the valve V2 and intercept the supply of water to the reforming fuel mixer/evaporator 103 (Step B17).

Finally, the control apparatus 130 outputs a signal to the control driver D3 for stopping the operation of driving the air pump P3 for supplying air (Step B19) and also signals for completely closing the valves V4, V5, V6 and V7 to completely close them and intercept the supply of air to the CO remover 105, the methanol catalyst burner 109, the off gas catalyst burner 111 and the power generation cell 120 (Step B21). As a result, the operation of the fuel cell system 200 completely stops.

Thus, when the power supply system of the above-described first embodiment is to be started, the supply of methanol is started only after the start of the supply of water and when the temperature of the reforming fuel mixer/evaporator 103 exceeds a predetermined temperature level. Therefore, there arises a period when the internal temperature of the reforming fuel mixer/evaporator 103 gradually rises and temporarily gets to a temperature level between the boiling point of water and that of methanol in the operation of starting the power supply system. However, since the supply of methanol is not started at this time, practically no methanol gas is produced in the reforming fuel mixer/evaporator 103. Then, methanol is supplied only when the temperature of the reforming fuel mixer/evaporator 103 rises to a sufficiently high level and the inside of the reforming fuel mixer/evaporator 103 becomes filled with steam so that it is possible to reduce the startup time of the power supply system and, at the same time, suppress the production of unreformed methanol gas.

When, on the other hand, the power supply system of the above-described embodiment is to be stopped, the supply of water is stopped only after stopping the supply of methanol and when the output of the power generation cell 120 falls below a predetermined output level. Therefore, there arises a period when the internal temperature of the reforming fuel mixer/evaporator 103 gradually falls and temporarily gets to a temperature level between the boiling point of water and that of methanol in the operation of stopping the power supply system. However, since the supply of methanol is already stopped at this time, the content ratio of unreformed methanol does not rise in the gas produced in the reforming fuel mixer/evaporator 103. Then, the supply of water is stopped when the output of the power generation cell 120 falls and the content ratio of unreformed methanol gas in the reforming fuel mixer/evaporator 103 becomes sufficiently low. Therefore, it is possible to reduce the time necessary for stopping the power supply system and, at the same time, suppress the production of unreformed methanol gas.

With the start control process and the stop control process of the power supply system as described above, it is possible to reduce the startup time and the time for stopping the power supply system and, at the same time, suppress the production of unreformed methanol gas. As the production of methanol gas is suppressed, the degradation by methanol gas of the catalyst held by the CO remover 105 is minimized and the CO remover 105 can sufficiently remove CO. Then, as a result, the operation of the power supply system is stabilized. Additionally, the start control process and the stop control process do not require a densitometer and the like that are costly and hence the above-described embodiment of power supply system is advantageous from the viewpoint of cost and can be downsized.

While the power supply system of FIG. 1 comprises a combustion fuel evaporator 101 and a methanol catalyst burner 109 and part of the methanol (power generation fuel) contained in the methanol tank 140 is used as combustion fuel for heating the reformer 107 and the CO remover 105 in the above description, the present invention is by no means limited thereto and, for example, the reformer 107 and the CO remover 105 may alternatively be heated to a predetermined reaction temperature by means of the off gas catalyst burner 111 and an electric heater to omit the combustion fuel evaporator 101 and the methanol catalyst burner 109. Furthermore, it may alternatively be so arranged that the reformer 107 and the CO remover 105 are heated only by an electric heater and the off gas catalyst burner 111 is omitted.

### Second Embodiment

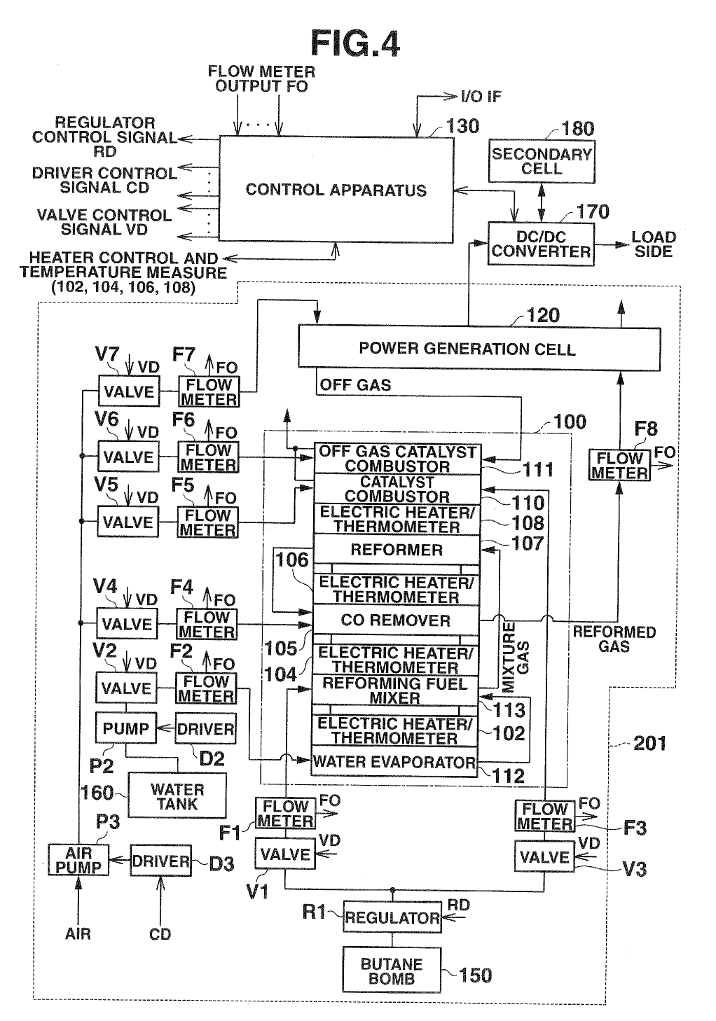

Now, the second embodiment of power supply system according to the invention will be described by referring to FIGS. 4 through 6. The power supply system of this embodiment comprises a fuel reforming type solid state polymer electrolyte fuel cell and is adapted to use gas fuel such as butane that is a principal ingredient of LPG as the power generation fuel.

FIG. 4 is a schematic block diagram of the second embodiment of power supply system according to the present invention, showing the configuration thereof.

The components of this embodiment that are same as or similar to those of the above-described first embodiment are denoted respectively by the same reference symbols and will not be described in detail or omitted. Thus, only the characteristic aspects of this embodiment will be described below.

The power supply system of this embodiment comprises a control apparatus (control section) 130, a DC/DC converter (voltage transformation section) 170, a secondary cell 180 and a fuel reforming type fuel cell system 201.

The fuel cell system 201 of this embodiment is adapted to use butane that is gas fuel at room temperature as the power generation fuel.

Thus, this embodiment is realized by eliminating the pump P1 and the control driver D1 for supplying methanol, adding a regulator R1 for regulating the pressure of butane and a regulator control signal RD for controlling the operation of driving the regulator and replacing the reforming fuel mixer/evaporator 103, the combustion fuel evaporator 101 and the methanol catalyst burner 109 respectively with a reforming fuel mixer 113, a water evaporator 112 and a catalyst burner 110 in block diagram of the first embodiment shown in FIG. 1.

The water evaporator 112 evaporates water supplied by means of the pump P2 and sends out steam to the reforming fuel mixer 113. The catalyst burner 110 burns butane supplied from a butane bomb 150 on a catalyst and the heat of combustion is used to heat the reformer 107 and the CO remover 105 and set them to a predetermined reaction temperature.

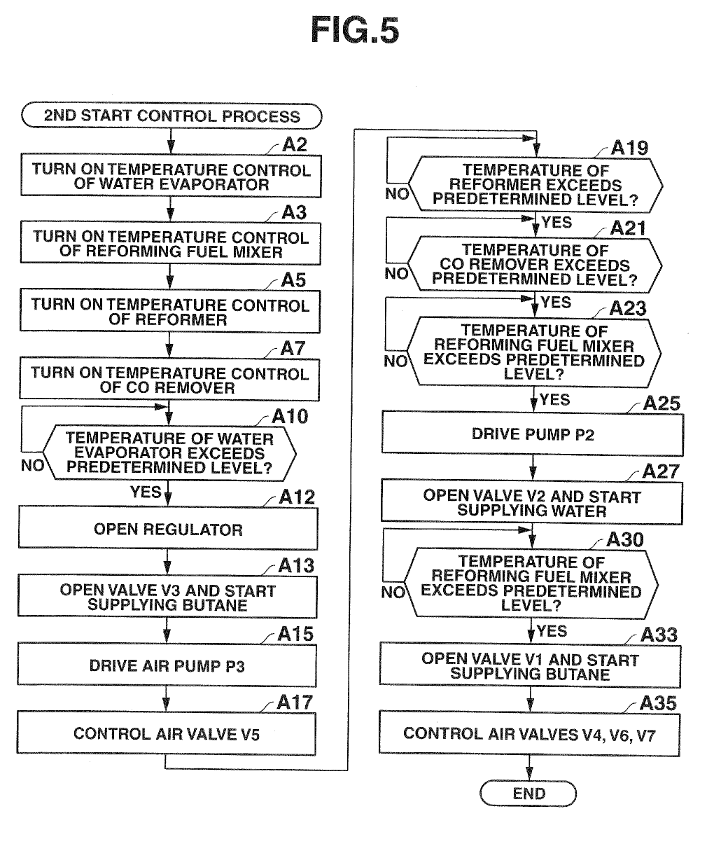

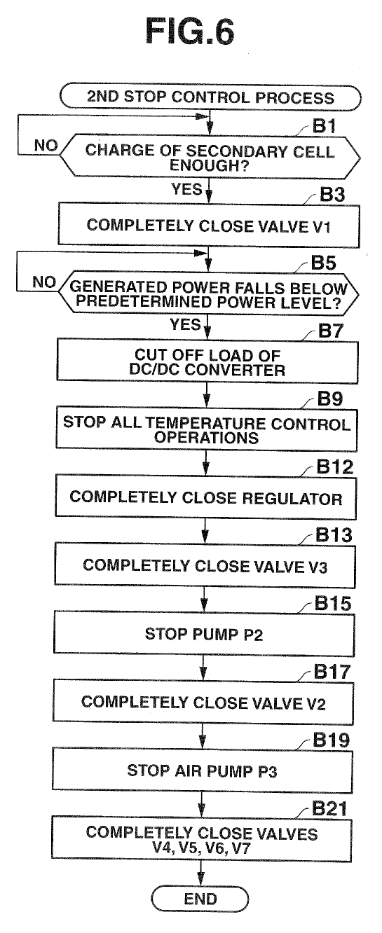

Now, the operation of the power supply system of this embodiment will be described by referring to FIGS. 5 and 6.

FIG. 5 is a flowchart of the start control process of this embodiment.

FIG. 6 is a flowchart of the stop control process of this embodiment.

As shown in FIG. 5, the start control process of this embodiment (the second start control process) is realized by replacing Steps A1 and A9 that relate to the combustion fuel evaporator 101, Step A11 where the control apparatus 130 outputs a signal to start driving the pump P1 for supplying methanol so as to start supplying methanol and Step A29 that relates to the reforming fuel mixer/evaporator 103 of the first start control process illustrated in FIG. 2 respectively with Step A2 and A10 that relate to the water evaporator 112, Step A12 where the control apparatus 130 outputs a signal for opening the regulator R1 so as to start supplying butane and Step A30 that relates to the reforming fuel mixer 113.

Thus, the control apparatus 130 firstly outputs a heater control signal for starting a temperature control operation to each of the electric heater/thermometers 102, 104, 106 and 108 in order to make them respectively start controlling the temperatures of the water evaporator 112, the reforming fuel mixer/evaporator 103, the reformer 107 and the CO remover 105 (Steps A2, A3, A5, A7).

Then, the control apparatus 130 determines if the temperature of the water evaporator 112 gauged by the electric heater/thermometer 102 has exceeded a predetermined temperature level or not (Step A10). The control apparatus 130 waits until the temperature exceeds the predetermined temperature level (Step A10: No). The processing operation of Step A10 is performed to determine if the temperature of the water evaporator 112 has got to a temperature level that is sufficiently high for evaporating at least water (e.g., about 100° C. which is the boiling point of water) or not.

When the temperature of the water evaporator 112 rises above the predetermined temperature level (Step A10: Yes), the control apparatus 130 outputs a signal for opening the regulator R1 for supplying butane (Step A12) and also a signal for opening the valve V3 in order to start supplying methanol to the catalyst burner 110 (Step A13).

Then, the control apparatus 130 outputs a signal for causing the driver D3 to drive the air pump P3 for supplying air to the power supply system (Step A15) and also a signal for causing it to open the valve V5 in order to start supplying air to the catalyst burner 110 (Step A17). As a result of the processing operations in Steps A12 through A17, butane is sent out to the catalyst burner 110 and burnt with air on the catalyst in the catalyst burner 110. The produced heat of combustion is then used to heat the reformer 107, the CO remover 105 and other components of the chemical reaction section 100.

Thereafter, the control apparatus 130 determines if the temperature of the reformer 107 gauged by the electric heater/thermometer 108 has exceeded a predetermined temperature level or not (Step A19). The control apparatus 130 waits until the temperature exceeds the predetermined temperature level (Step A19: No). The processing operation of Step A19 is performed to determine if the temperature of the reformer 107 has got to a temperature level that is sufficiently high for at least proceeding with a reforming reaction expressed by the formula (1) (e.g., about 300° C.) or not.

When the temperature of the reformer 107 rises above the predetermined temperature level (Step A19: Yes), the control apparatus 130 determines if the temperature of the CO remover 105 gauged by the electric heater/thermometer 106 has exceeded a predetermined temperature level or not (Step A21). The control apparatus 130 waits until the temperature exceeds the predetermined temperature level (Step A21: No). The processing operation of Step A21 is performed to determine if the temperature of the CO remover 105 has got to a temperature level that is sufficiently high for at least proceeding with chemical reactions expressed by the formulas (3) and (4) (e.g. 60 to 80° C.) or not.

When the temperature of the CO remover 105 rises above the predetermined temperature level (Step A21; Yes), the control section 130 determines if the temperature of the reforming fuel mixer/evaporator 103 gauged by the electric heater/thermometer 104 has exceeded a predetermined temperature level or not (Step A23). The control apparatus 130 waits until the temperature exceeds the predetermined temperature level (Step A23: No). The processing operation of Step A23 is performed to determine if the temperature of the reforming fuel mixer/evaporator 103 has got to a temperature level that is sufficiently high for at least evaporating water (e.g., about 100° C. which is the boiling point of water) or not.

When the temperature of the reforming fuel mixer/evaporator 103 rises above the predetermined temperature (Step A23: Yes), the control apparatus 130 outputs a signal for causing the driver D2 to drive the pump P2 for supplying water (Step A25) and also a signal for causing it to open the valve V2 in order to start supplying water to the water evaporator 112 (Step A27). Since only water is supplied to the water evaporator 112 and no butane is supplied to the reforming fuel mixer 113, the reformer 107, the CO remover 105 and the piping connecting them are gradually filled with steam.

Then, the control apparatus 130 determines if the temperature of the reforming fuel mixer 112 gauged by the electric heater/thermometer 104 has exceeded a predetermined temperature level or not (Step A30). The control apparatus 130 waits until the temperature exceeds the predetermined temperature level (Step A30: No). The processing operation of Step A30 is performed to determine once again if the temperature of the reforming fuel mixer 112 that has fallen temporarily by the water injected into the reforming fuel mixer 112 in the processing operations of Steps A25 and A27 exceeds a temperature level that is sufficiently high for at least evaporating water (e.g., about 100° C. which is the boiling point of water) or not.

Subsequently, when the temperature of the reforming fuel mixer 112 rises above the predetermined temperature level (Step A30: YES), the control apparatus 130 outputs a signal for opening the valve V1 to start supplying butane to the reforming fuel mixer 112 (Step A33). As a result of the processing operation in Step A33, butane is supplied to the reforming fuel mixer 112 and the reforming fuel mixer 112 produces the mixture gas of butane and steam, which the mixture gas is then sent out to the reformer 107. Thus, a reforming reaction as expressed by the formula (1) progresses in the reformer 107.

Then, the control apparatus 130 outputs a signal for opening the valves V4, V6 and V7 to start supplying air to the CO remover 105, the off gas catalyst burner 111 and the power generation cell 120 (Step A35).

As a result, shift reactions as expressed by the formulas (3) and (4) progress in the CO remover 105 and a catalyst combustion reaction progresses in the off gas catalyst burner 111, while electrochemical reactions as expressed by the formulas (5) and (6) progress in the power generation cell 120 so that the power generation cell 120 starts generating electricity.

Thus, as in the case of the above-described first start control process, with the second start control process, it is possible to reduce the startup time of the power supply system and, at the same time, suppress the production of unreformed methanol gas.

Now, referring to FIG. 6, the stop control process of this embodiment (the second stop control process) is realized by replacing Step B11 of the first stop control process of FIG. 3 where the control apparatus 130 outputs a signal for stopping the operation of driving the pump P1 to the driver D1 with Step B12 where the control apparatus 130 outputs a signal for completely closing the regulator R1 to cut off the supply of butane.

The control apparatus 130 firstly determines if the electric power accumulated in the secondary cell 180 that is charged from the DC/DC converter 170 exceeds a predetermined power level or not in order to determine if the charge of the power supply system is enough or not (Step B1). The control apparatus 130 waits until it determines that the charge is enough (Step B1: No).

If it is determined that the electric power accumulated is enough (Step B1: Yes), the control apparatus 130 outputs a control signal for completely closing the valve V1 for supplying butane to the reforming fuel mixer 112 and cuts off the supply of butane to the reforming fuel mixer 112 (Step B3). At this time, the supply of water to the water evaporator 112 still continues. Thus, as a result of the processing operation of Step B3, only steam is supplied to the reforming fuel mixer 112 by way of the water evaporator 112.

Then, the control apparatus 130 determines if the electric power generated by the power generation cell 120 is lower than a predetermined power level or not by way of the DC/DC converter 170 (Step B5) and waits until the electric power generated by the power generation cell 120 becomes lower than the predetermined power level (Step B5: No). At this time, while only water is supplied to the reforming fuel mixer 103, the reforming reaction continues in the reformer 107 so that reformed gas is no longer produced and supplied to the power generation cell 120 when all the unreformed methanol gas is reformed in the reformer 107. Then, the power output of the power generation cell 120 gradually falls. Thus, the processing operation of Step B5 is performed to detect that all the unreformed methanol gas has been reformed.

Then, as the power output of the power generation cell 120 falls under a predetermined power level (Step B5: Yes), the control apparatus 130 stops the supply of electric power to the load by way of the DC/DC converter 170 (Step B7).

Thereafter, the control apparatus 130 outputs a heater control signal to each of the electric heater/thermometers 102, 104, 106 and 108 (Step B9) in order to make them stop their respective temperature controlling operations. It also outputs a signal for completely closing the regulator R1 for supplying butane (Step B12) and a signal for completely closing the valve V3 to cut off the supply of butane to the catalyst burner 110 (Step B13).

Subsequently, the control apparatus 130 outputs a signal for causing the control driver D2 to stop driving the pump P2 for supplying water to the water evaporator 112 (Step B15) and also a signal for completely closing the valve V2 so as to completely close the valve V2 and intercept the supply of water to the water evaporator 112 (Step B17).

Finally, the control apparatus 130 outputs a signal to the control driver D3 for stopping the operation of driving the air pump P3 for supplying air (Step B19) and also signals for completely closing the valves V4, V5, V6 and V7 to completely close them and intercept the supply of air to the CO remover 105, the catalyst burner 110, the off gas catalyst burner 111 and the power generation cell 120 (Step B21). As a result, the operation of the fuel cell system 201 completely stops.

All the subsequent operations after Step B13 are same as those of the first start control process.

Thus, as in the case of the above-described first stop control process, with the second start control process, it is possible to reduce time necessary for the operation of stopping the power supply system and, at the same time, suppress the production of unreformed methanol gas.

The second embodiment of power supply system adapted to use gas fuel such as butane as the power generation fuel provides advantages similar to those of the first embodiment.

### Third Embodiment

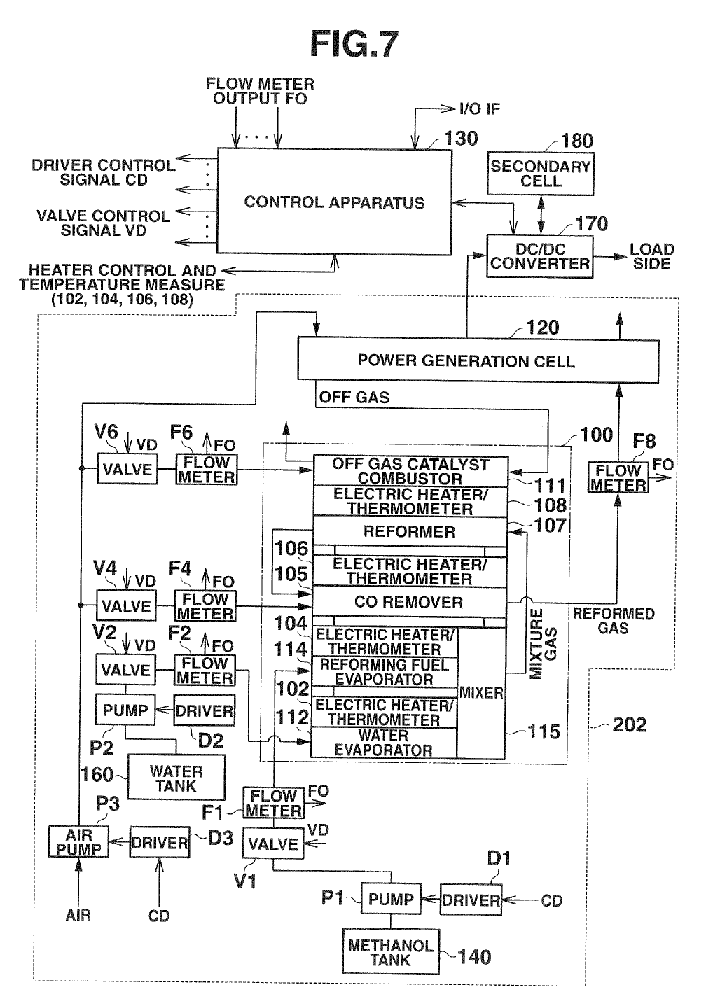

Now, the third embodiment of power supply system according to the invention will be described by referring to FIGS. 7 through 9. The power supply system of this embodiment comprises a fuel reforming type solid state polymer electrolyte fuel cell and is adapted to use liquid fuel such as methanol as the power generation fuel.

FIG. 7 is a schematic block diagram of the third embodiment of power supply system according to the present invention, showing the configuration thereof.

The components of this embodiment that are same as or similar to those of the above-described first and second embodiments are denoted respectively by the same reference symbols and will not be described in detail or omitted. Thus, only the characteristic aspects of this embodiment will be described below.

The power supply system of this embodiment comprises a control apparatus (control section) 130, a DC/DC converter (voltage transformation section) 170, a secondary cell 180 and a fuel reforming type fuel cell system 202.

The fuel cell system 202 of this embodiment is adapted to evaporate methanol and water and subsequently mix them. For this reason, this embodiment is realized by eliminating the reforming fuel mixer/evaporator 103 and adding a water evaporator (the first evaporator) 112 for evaporating water, a reforming fuel evaporator (the second evaporator) 114 for evaporating methanol and a mixer 115 for mixing evaporated methanol and steam in block diagram of the first embodiment shown in FIG. 1. The water evaporator 112 is equipped with the electric heater/thermometer 102 for the purpose of temperature control, while the reforming fuel evaporator 114 is equipped with the electric heater/thermometer 104 for the purpose of temperature control. Since the mixer 115 mixes gases, it can be made smaller than a mixer for mixing liquids.

In the fuel cell system 202, the reformer 107, the CO remover 105 and other components of the chemical reaction section 100 are heated only by the heat of combustion generated from the electric heater/thermometer 108 and the off gas catalyst burner 111 to set them to a predetermined reaction temperature so that the combustion fuel evaporator 101, the methanol catalyst burner 109 and the valves V3 and V5 and the flow meters F3 and F5 that accompany them of the first embodiment are eliminated from the third embodiment.

Additionally, in the fuel cell system 202, the valve V7 and the flow meters F7 and F8 of the first and second embodiments for regulating the rate of power generation of the power generation cell 120 by way of the rates of supplying methanol, water and air are eliminated.

With this arrangement, it is possible to reduce both the size and the weight of the fuel cell system 202 of this embodiment if compared with the fuel cells system 200 and 201 of the first and second embodiments so as to realize a power supply system suitable for portable electronic apparatus.

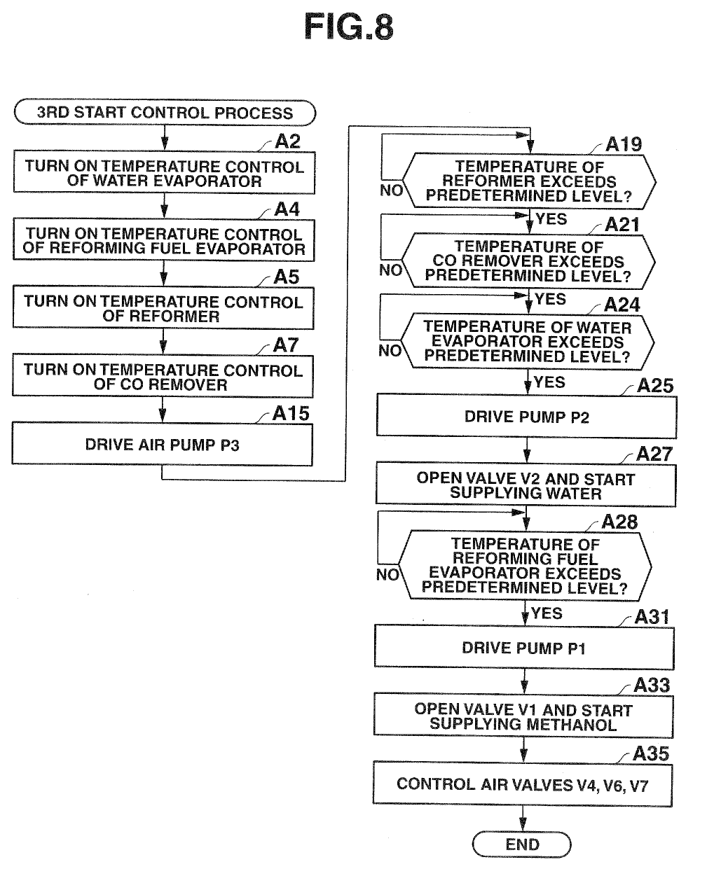

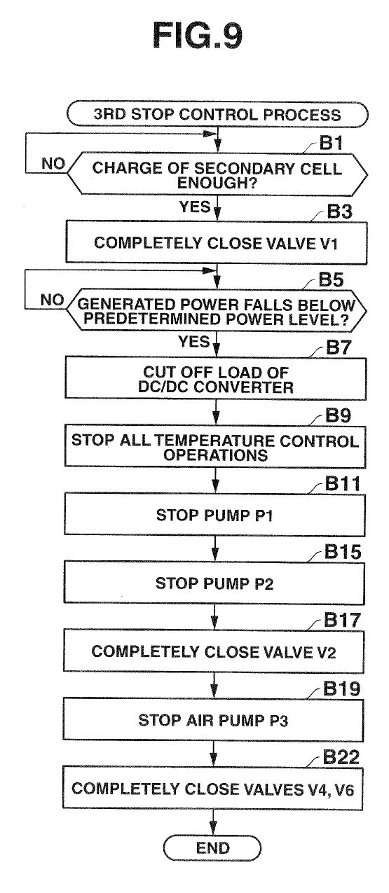

Now, the operation of the power supply system of this embodiment will be described by referring to FIGS. 8 and 9.

FIG. 8 is a flowchart of the start control process of this embodiment.

FIG. 9 is a flowchart of the stop control process of this embodiment.

As shown in FIG. 8, the start control process of this embodiment (the third start control process) is realized by replacing Step A1 that relates to the combustion fuel evaporator 101 and Step A3 that relates to the reforming fuel mixer/evaporator 103 respectively with Step A2 that relates to the water evaporator 112 and Step A4 that relates to the reforming fuel evaporator 114, eliminating Step A9 that relates to the combustion fuel evaporator 101, Step A11 that relates to the pump P1 and Step A13 that relates to the valve V13, replacing Steps A23 and A29 that relate to the reforming fuel mixer/evaporator 103 respectively with Step A24 that relates to the water evaporator 112 and Step A28 that relates to the reforming fuel evaporator 114 and inserting Step A30 for driving the pump P1 between Step A28 and Step A31 in the first start control process of FIG. 2.

The control apparatus 130 firstly outputs a heater control signal for starting a temperature control operation to each of the electric heater/thermometers 102, 104, 106 and 108 in order to make them respectively start controlling the temperatures of the water evaporator 112, the reforming fuel evaporator 114, the reformer 107 and the CO remover 105 (Steps A2, A4, A5, A7).

Then, the control apparatus 130 outputs a signal for causing the driver D3 to drive the air pump P3 for supplying air to the power supply system (Step A15) in order to make it start supplying air to the power generation cell 120.

Thereafter, the control apparatus 130 determines if the temperature of the reformer 107 gauged by the electric heater/thermometer 108 has exceeded a predetermined temperature level or not (Step A19). The control apparatus 130 waits until the temperature exceeds the predetermined temperature level (Step A19: No). The processing operation of Step A19 is performed to determine if the temperature of the reformer 107 has got to a temperature level that is sufficiently high for at least proceeding with a reforming reaction expressed by the formula (1) (e.g., about 300° C.) or not.

When the temperature of the reformer 107 rises above the predetermined temperature level (Step A19: Yes), the control apparatus 130 determines if the temperature of the CO remover 105 gauged by the electric heater/thermometer 106 has exceeded a predetermined temperature level or not (Step A21). The control apparatus 130 waits until the temperature exceeds the predetermined temperature level (Step A21: No). The processing operation of Step A21 is performed to determine if the temperature of the CO remover 105 has got to a temperature level that is sufficiently high for at least proceeding with chemical reactions expressed by the formulas (3) and (4) (e.g. 60 to 80° C.) or not.

When the temperature of the CO remover 105 rises above the predetermined temperature level (Step A21; Yes) the control section 130 determines if the temperature of the water evaporator 112 gauged by the electric heater/thermometer 104 has exceeded a predetermined temperature level or not (Step A24). The control apparatus 130 waits until the temperature exceeds the predetermined temperature level (Step A24: No). The processing operation of Step A24 is performed to determine if the temperature of the water evaporator 112 has got to a temperature level that is sufficiently high for at least evaporating water (e.g., about 100° C. which is the boiling point of water) or not.

When the temperature of the water evaporator 112 rises above the predetermined temperature (Step A24: Yes), the control apparatus 130 outputs a signal for causing the driver D2 to drive the pump P2 for supplying water (Step A25) and also a signal for causing it to open the valve V2 in order to start supplying water to the reforming fuel mixer/evaporator 103 (Step A27). Since water is supplied to the water evaporator 112 but no methanol is supplied to the reforming fuel evaporator 114, the mixer 115, the reformer 107, the CO remover 105 and the piping connecting them are gradually filled with steam.

Then, the control apparatus 130 determines if the temperature of the reforming fuel evaporator 114 gauged by the electric heater/thermometer 104 has exceeded a predetermined temperature level or not (Step A28). The control apparatus 130 waits until the temperature exceeds the predetermined temperature level (Step A28: No). The processing operation of Step A28 is performed to determine once again if the temperature of the reforming fuel evaporator 114 that has fallen temporarily by the water injected into the reforming fuel evaporator 114 in the processing operations of Steps A25 and A27 exceeds a temperature level that is sufficiently high for at least evaporating water (e.g., about 100° C. which is the boiling point of water) or not.

Subsequently, when the temperature of the reforming fuel evaporator 114 rises above the predetermined temperature level (Step A28: YES), the control apparatus 130 outputs a signal for causing the control driver D1 to start driving the pump P1 for supplying methanol and also a signal for opening the valve V1 so as to start supplying methanol to the reforming fuel evaporator 114 (Step A33).

Then, the control apparatus 130 outputs a signal for opening the valves V4, V6 and V7 to start supplying air to the CO remover 105, the off gas catalyst burner 111 and the power generation cell 120 (Step A35).

As a result, shift reactions as expressed by the formulas (3) and (4) progress in the CO remover 105 and a catalyst combustion reaction progresses in the off gas catalyst burner 111, while electrochemical reactions as expressed by the formulas (5) and (6) progress in the power generation cell 120 so that the power generation cell 120 starts generating electricity.

With the third start control process, water is evaporated by the water evaporator 112 and subsequently methanol is evaporated by the reforming fuel evaporator 114 so that evaporated methanol and steam are mixed with each other. Thus, the content ratio of methanol never rises too high relative to steam so that it is possible to reduce the startup time of the power supply system and, at the same time, suppress the production of unreformed methanol gas.

Now, referring to FIG. 9, the stop control process of this embodiment (the third stop control process) is realized by eliminating Step B13 relating to the valve V3 and replacing Step B21 of the first stop control process where the control apparatus 130 outputs signals for completely closing the valves V4, V5, V6 and V7 to cut off the supply of air to the CO remover 105, the methanol catalyst burner 109, the off gas catalyst burner 111 and the power generation cell 120 with Step B22 where the control apparatus 130 outputs signals for completely closing only the valves V4 and V6 to cut off the supply of air to the CO remover 105 and the off gas catalyst burner 111 in the first stop control process of FIG. 3 so that no signal is output for completely closing the valves V5 and V7 to cut off the supply of air to the methanol catalyst burner 109 and the power generation cell 120.

The control apparatus 130 firstly determines if the electric power accumulated in the secondary cell 180 that is charged from the DC/DC converter 170 exceeds a predetermined power level or not in order to determine if the charge of the power supply system is enough or not (Step B1). The control apparatus 130 waits until it determines that the charge is enough (Step B1: No).

If it is determined that the electric power accumulated in the secondary cell 180 is enough (Step B1: Yes), the control apparatus 130 outputs a signal for completely closing the valve V1 for supplying methanol to the reforming fuel mixer/evaporator 103 and cuts off the supply of methanol to the reforming fuel mixer/evaporator 103 (Step B3). At this time, the valve V2 for supplying water to the reforming fuel mixer/evaporator 103 is continuously held open. Thus, as a result of the processing operation of Step B3, the supply of methanol to the reforming fuel evaporator 114 is intercepted.

Then, the control apparatus 130 determines if the electric power generated by the power generation cell 120 is lower than a predetermined power level or not by way of the DC/DC converter 170 (Step B5) and waits until the electric power generated by the power generation cell 120 becomes lower than the predetermined power level (Step B5: No). At this time, no methanol is supplied to the reforming fuel evaporator 114 but the supply of water to the water evaporator 112 is continued and the reforming reaction also continues in the reformer 107 so that reformed gas is no longer produced and supplied to the power generation cell 120 when all the unreformed methanol gas is reformed in the reformer 107. Then, the power output of the power generation cell 120 gradually falls. Thus, the processing operation of Step B5 is performed to detect that all the unreformed methanol gas has been reformed.

Then, as the power output of the power generation cell 120 falls under a predetermined power level (Step B5: Yes), the control apparatus 130 stops the supply of electric power to the load by way of the DC/DC converter 170 (Step B7).

Thereafter, the control apparatus 130 outputs a heater control signal to each of the electric heater/thermometers 102, 104, 106 and 108 (Step B9) in order to make them stop their respective temperature controlling operations. It also outputs a signal for causing the control driver D1 to completely close the pump P1 for supplying methanol (Step B11).

Subsequently, the control apparatus 130 outputs a signal for causing the control driver D2 to stop driving the pump P2 for supplying water to the water evaporator 112 (Step B15) and also a signal for completely closing the valve V2 so as to completely close the valve V2 and intercept the supply of water to the water evaporator 112 (Step B17).

Finally, the control apparatus 130 outputs a signal to the control driver D3 for stopping the operation of driving the air pump P3 for supplying air (Step B19) and also signals for completely closing the valves V4 and V6 to completely close them and intercept the supply of air to the CO remover 105, the off gas catalyst burner 111 and the power generation cell 120 (Step B22). As a result, the operation of the fuel cell system 202 completely stops.

With the third stop control process, the operation of evaporating water in the water evaporator 112 is stopped after stopping the operation of evaporating methanol in the reforming fuel evaporator 114 so that the content ratio of methanol relative to steam does not rise and hence it is possible to reduce the time necessary for the operation of stopping the power supply system and, at the same time, suppress the production of unreformed methanol gas.

Thus, the third embodiment of power supply system provides advantages similar to those of the first embodiment.

### Modifications to the Embodiments

While methanol is used as the power generation fuel in the first and third embodiments, it may be replaced by some other hydrocarbon type liquid fuel such as ethanol or gasoline. While the water tank 160 and the methanol tank 140 are used separately in the first and third embodiments, they may be replaced by a single tank having regions in the inside for containing water and methanol separately.

While butane is used as the power generation fuel in the second embodiment, it may be replaced by some other hydrocarbon type gas fuel such as methane, dimethylether, town gas or propane gas. Additionally, a preheater may be provided between the regulator and the butane bomb for the purpose of reducing the startup time and improving the thermal efficiency.

The present invention is applied to a solid state polymer electrolyte fuel cell (PEFC) in the above description of the first and third embodiments, the present invention can also be applied to a solid oxide electrolyte fuel cell (SOFC). When the present invention is applied to an SOFC that uses hydrocarbon type fuel, it is possible to suppress the phenomenon of depositing carbon at the electrodes by using hydrocarbon type fuel without reforming. Then, it is possible to prevent the power generation performance from degrading as in the case of the first and third embodiments.

The water evaporator 112 and the reforming fuel evaporator 114 of the third embodiment of power supply system are provided respectively with the electric heater/thermometers 102, 104 for controlling them in the above description. However, they may alternatively be controlled by a single common electric heater/thermometer.

While the operation of supplying fuel, water and air and that of cutting off the supply of fuel, water and air are controlled by controlling valves and pumps in the above description of the embodiments, only pumps may alternatively be used to control the operation of supplying fuel, water and air and that of cutting off the supply of fuel, water and air.

### <Electronic Apparatus>

Now, an electronic apparatus comprising a power supply system of any of the first through third embodiments will be described below.

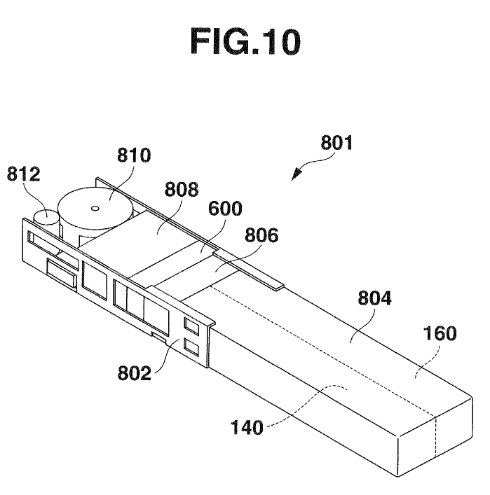

FIG. 10 is a schematic perspective view of a power generation unit realized by applying a power supply system according to the present invention.

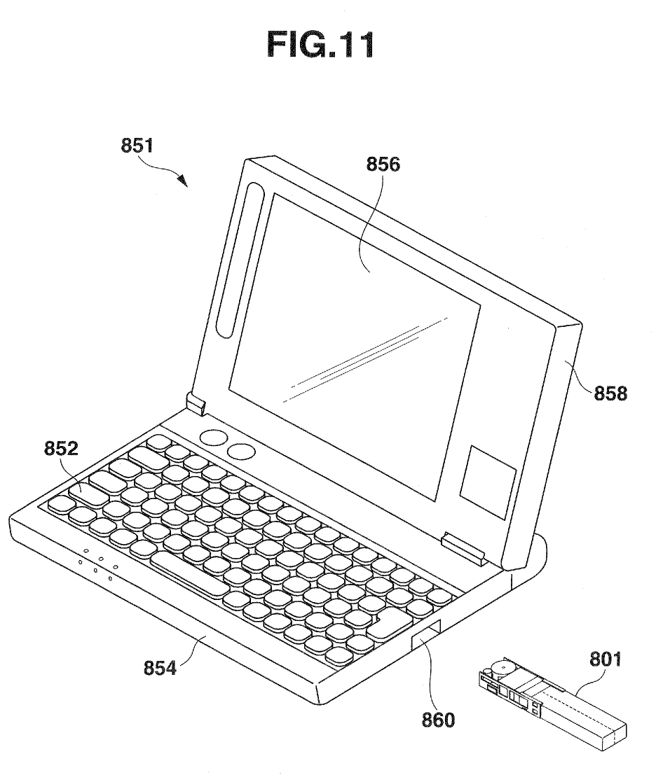

FIG. 11 is a schematic perspective view of an electronic apparatus adapted to use a power generation unit realized by applying a power supply system according to the present invention.

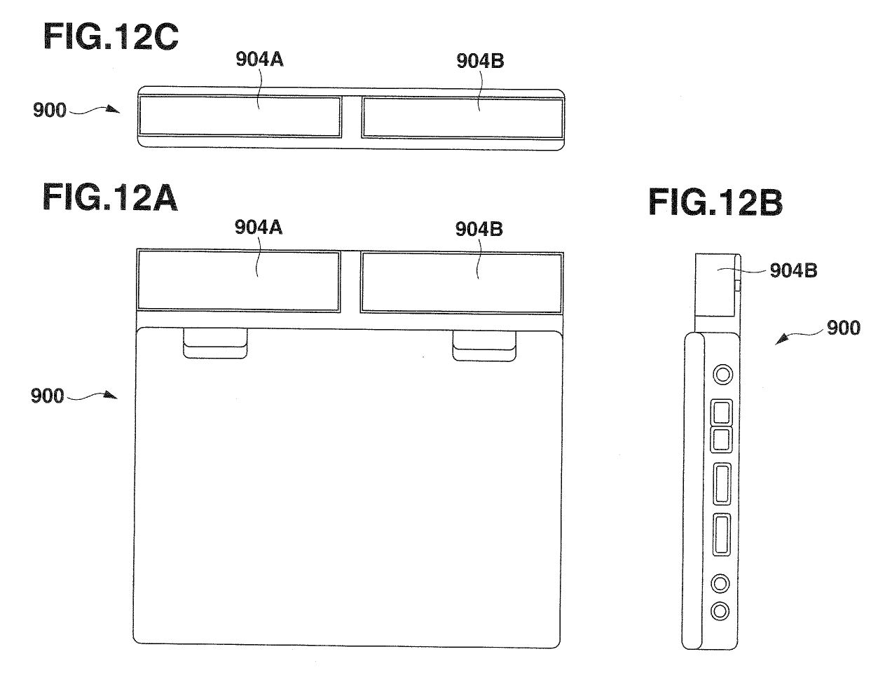

FIG. 12 is a tri-lateral view of another electronic apparatus adapted to use a power supply system according to the present invention.

Any of the above-described embodiments of power supply system may be used by mounting it in a power generation unit 801 as shown in FIG. 10. Referring to FIG. 10, the power generation unit 801 typically comprises a frame 802, a fuel container 804 including a methanol tank 140 and a water tank 160 as integral parts thereof and adapted to be removably fitted to the frame 802, a flow rate control unit 806 including flow paths, pumps, flow rate sensors and valves, a micro-reactor module 600 contained in a heat-insulating package 791, a power generation cell 808 including a fuel cell, a humidifier, a recovery container and so on, an air pump 810 and a power supply unit 812 including a secondary cell, a DC/DC converter, an external interface and so on. Hydrogen gas is produced as the mixture gas obtained from water and liquid fuel in the fuel container 804 is supplied by the flow rate control unit 806 and supplied to the fuel cell of the power generation cell 808. Then, generated electricity is accumulated in the secondary cell of the power supply unit 812.

The power generation unit 801 is mounted in, for example, the electronic apparatus 851 as shown in FIG. 11.

The electronic apparatus 851 is a portable electronic apparatus such as a notebook type personal computer. The electronic apparatus 815 contains in the inside thereof a processing circuit formed by a CPU, a RAM, a ROM and other electronic parts and is provided with a lower cabinet body 854 that contains the processing circuit and is equipped with a keyboard 852 and an upper cabinet body 858 that is equipped with a liquid crystal display 856. The lower cabinet body 854 and the upper cabinet body 858 are linked to each other by means of hinges in such a way that they may be laid one on the other with the keyboard 852 and the liquid crystal display 856 facing each other. A mount section 860 is formed to extend from the light lateral surface to the bottom surface of the lower cabinet body 854 and receive the power generation unit 801 in it. Thus, as the power generation unit 801 is mounted in the mount section 860, the electronic apparatus 851 is powered by the power generation unit 801 to operate.

The electronic apparatus 900 illustrated in FIG. 12 comprises two fuel containers 904A, 904B that can removably fitted to it, each integrally having a methanol tank 140 and a water tank 160. The electronic apparatus 900 contains components other than the fuel containers 904A, 904B and is provided with a recessed mount section for receiving the fuel container 904A, 904B. As the fuel containers 904A, 904B are mounted in the mount section, methanol and water are supplied into the electronic apparatus 900 from the fuel containers 904A, 904B. As the electronic apparatus 900 is provided with a plurality of fuel containers 904A, 904B, if one of the fuel containers becomes short of methanol or water, it is possible to use methanol or water, whichever appropriate in the other fuel container. Thus, the empty fuel container can be taken out, refilled with methanol and water and mounted back in the electronic apparatus 900 while the electronic apparatus 900 is continuously being operated.

Alternatively, only the methanol tank or tanks 140 may be removably fitted to the electronic apparatus 900 and the electronic apparatus 900 may be provided in the inside thereof with a water tank 160. The water tank 160 may be so adapted as to collect and store the water produced by the fuel cell.

1. A power supply system comprising:
a chemical reaction section (100) comprising
a evaporation section (103, 112, 114) that receives a power generation fuel and water supplied to it, heating at least the water supplied to it to evaporate it; and
a reaction section (105, 107) that generates a power generation gas on the basis of the steam generated by the evaporation section and the power generation fuel;
a fuel supply section (P1, V1) that supplies the power generation fuel to the chemical reaction section;
a water supply section (P2, V2) that supplies water to the chemical reaction section; and
a control section (130) that controls the operation of the system so as to stop supply of the power generation fuel from the fuel supply section to the chemical reaction section when the evaporation section is not in a condition suitable for evaporating operation.

2. The system according to claim 1, wherein
the evaporation section is adapted to evaporate the power generation fuel supplied to it.

3. The system according to claim 2, wherein
the evaporation section comprising:
a first evaporation section (112) that heats and evaporates the water;
a second evaporation section (114) that evaporates the power generation fuel supplied to it; and
a mixer (115) that mixes the steam produced by the first evaporation section and the evaporated power generation fuel produced by the second evaporation section and supplies the mixture to the reaction section.

4. The system according to claim 1, wherein
the power generation fuel is a liquid fuel in which composition contains the hydrogen atom; and
the evaporation section evaporates the water and the power generation fuel; and that
the reaction section (107) comprises a reform section for receiving the mixture gas of the power generation fuel and steam evaporated by the evaporation section and producing hydrogen-containing reformed gas by means of a reform reaction and a carbon monoxide removal section (105) for removing carbon monoxide contained in the reformed gas and producing the power generation gas.

5. The system according to claim 1, wherein
the power generation fuel is a gas fuel in which composition contains the hydrogen atom; and
the reaction section (107) comprises a reform section for receiving the mixture gas of steam produced by the evaporation section and gas fuel and producing hydrogen-containing reformed gas by means of a reform reaction and a carbon monoxide removal section (105) for removing carbon monoxide contained in the reformed gas and producing the power generation gas.

6. The system according to claim 1, further comprising a temperature detection section for detecting the temperature of the evaporation section, wherein the control section controls so as to stop supply of the power generation fuel from the fuel supply section to the chemical reaction section when the temperature of the evaporation section as detected by the temperature detection section is lower than a predetermined temperature.

7. The system according to claim 6, wherein
the predetermined temperature is the boiling point of water.

8. The system according to claim 1, further comprising:
a power generation section (120) that receives the power generation gas supplied to it and generates power for driving a load by way of an electrochemical reaction.

9. The system according to claim 8, wherein
when starting operating the power generation section, the control section causes the evaporation section to start operating and also the water supply section to start supplying water to the chemical reaction section, and causes the fuel supply section to supply the power generation fuel to chemical reaction section after the evaporation section comes into a condition suitable for the operation of evaporating water.

10. The system according to claim 8, further comprising an output detection section for detecting the output of the power generation section and when causing the power generation section to stop operating,
the control section stops the supply of the power generation fuel from the fuel supply section to the chemical reaction section and that causes the evaporation section to stop operating and stops the supply of water from the water supply section to the chemical reaction section after the output of the power generation section falls under a predetermined value as detected by the output detection section.

11. The system according to claim 8, wherein
the load is an electronic apparatus (851, 900).

12. The system according to claim 8, wherein
the power supply system is at least partly integrally formed with the load.

13. The system according to claim 12, further comprising a fuel containing section (140, 160, 804) containing the power generation fuel in a sealed condition,
wherein the power supply system is integrally formed with the load except the fuel containing section.

14. The system according to claim 8, wherein
the system is formed as a module (801) that is configured to removably fitted to the load.

15. A method of controlling a power supply system which comprises a chemical reaction section comprising:
a evaporation section that receives a power generation fuel and water supplied to it and heating and evaporating water, and
a reaction section that generates a power generation gas on the basis of the steam generated by the evaporation section and the power generation fuel; and
a power generation section that receives the power generation gas supplied to it and generates power by way of an electrochemical reaction;
wherein when starting to operate the power generation section the method comprises:
causing the evaporation section to start operating;
causing the water supply section to start supplying water to the chemical reaction section;
waiting until the evaporation section comes into a condition suitable for the operation of evaporating water; and
causing the fuel supply section to start supplying the power generation fuel to chemical reaction section when the evaporation section comes into a condition suitable for the operation of evaporating water.

16. The method according to claim 15, wherein
the power supply system further comprises a temperature detection section for detecting the temperature of the evaporation section; and
the sequence of waiting until the evaporation section comes into a condition suitable for the operation of evaporating water comprises a sequence of waiting until the temperature of the evaporation section detected by the temperature detection section becomes higher than a predetermined temperature.

17. The method according to claim 15, wherein
the predetermined temperature is the boiling point of water.

18. The method according to claim 15, when stopping the operation of the power generation section, further comprises a sequence of stopping the supply of the power generation fuel from the fuel supply section to the chemical reaction section;
waiting until the output of the power generation section falls under a predetermined value; and
causing the evaporation section to stop operating and also the water supply section to stop supplying water to the chemical reaction section when the output of the power generation section falls under the predetermined value.

19. The method according to claim 18, wherein
the power supply system further comprises an output detection section for detecting the output of the power generation section; and
the sequence of waiting until the output of the power generation section falls under the predetermined value comprises a sequence of waiting until the output of the power generation section detected by the output detection section falls under the predetermined value.
